(19) United States
(12) Patent Application Publication
(10) Pub. No.: US 2016/0012556 A1
(43) Pub. Date: Jan. 14, 2016

(54) Method and System of Creating and Signing Electronic Documents With Increased Party-Signatory Accuracy and Execution Integrity

(71) Applicants: Charley Moore, San Francisco, CA (US); Stanley Withouski, San Francisco, CA (US); An Tran, San Francisco, CA (US); Sharadha Eswar, San Francisco, CA (US); Lok Man Leung, San Francisco, CA (US); Lizz Milota, San Francisco, CA (US)

(72) Inventors: Charley Moore, San Francisco, CA (US); Stanley Withouski, San Francisco, CA (US); An Tran, San Francisco, CA (US); Sharadha Eswar, San Francisco, CA (US); Lok Man Leung, San Francisco, CA (US); Lizz Milota, San Francisco, CA (US)

(73) Assignee: ROCKET LAWYER INCORPORATED, San Francisco, CA (US)

(21) Appl. No.: 14/331,007

(22) Filed: Jul. 14, 2014

(51) Int. Cl. G06Q 50/18; G06F 17/24; H04L 12/18; G06Q 10/10

(52) U.S. Cl. CPC G06Q 50/18; G06Q 10/10; G06F 17/24; H04L 12/1822

(57) ABSTRACT

Systems and methods for writing, changing, authenticating and signing web-based documents use an interactive questionnaire methodology and various databases to obtain document content, confirmation of the finality of a proposed document and participant identity verification. Multiple databases may be accessed and/or created to triangulate or otherwise confirm that a purported party to be bound by a legal instrument is the same party adding information to the document and that all parties to be bound by a contract have signed the same final version of the contract. Disclosed embodiments allow participants to change the terms of a proposed agreement that has been signed by others. A modified proposed agreement may be signed by the amending party and then offered to all interested parties.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### BACKGROUND OF THE INVENTION

(1) Field of the Invention

The invention generally relates to systems and methods of creating electronic documents and verifying the authenticity of electronic signatures. More particularly, the invention relates to the use of multiple databases to verify or triangulate a party's purported identity and signatory authority and to enable contract negotiation by network enabled round-robin amendments and signatures.

(2) Description of the Related Art

The Electronic Signatures in Global and National Commerce Act (E-SIGN Act) and the Uniform Electronic Transactions Act (UETA) allow the use of compliant electronic signatures to execute many types of legally binding documents remotely or over a network and without a traditional manual signature or wet signature.

Many businesses provide online or networked based forms and document templates for creating legal documents, but not all offer the application of electronic signatures, as the compliance requirements for E-SIGN Act and the UETA (sometimes collectively referred to as “the E-Acts”) are beyond the technical prowess and budgets of most online document businesses. Under the E-Acts electronic and/or signature systems are required to provide, inter alia, notifications, record keeping, and transactional integrity.

The prior art includes unduly complex and expensive mechanisms for complying with the E-Acts. While the prior art does include encryption and cryptographic signing schemes, there is a long felt need in the related art to more efficient robust and secure means of document creation and electronic signature application and verification. There is also a need in the art for means and methods of adapting to parties changing the terms of a proposed contract after other parties have signed the contract. The known prior art also fails to access, correlate or triangulate multiple databases to confirm the purported identity of a signing party and to confirm that a signing party may actually have an ownership or other interest in the substance of a contract. In other words, known prior art fails to map or triangulate the subject matter of a proposed legal document to the assets held by a proposed party. Such a short fall could lead to individuals, even with a verified identity, entering into contracts without authority to do so.

There are many prior art mechanisms to create and execute web-based or networked based contracts and instruments. One common approach utilizes a document template and an attached digital signature, wherein the document author inputs information into a document template through the use of user interface form fields. Once all the required fields are complete, each identified as a signatory creates a digital signature using graphical, cryptographic, biometric, or other means, which is subsequently applied to a document said to be finalized. The document and applied digital signatures is then regarded as an executed contract.

Beyond the technical and legal requirements for electronic signatures is the practical matter of developing end-user trust and confidence in electronic signatures. The everyday ease of copying, transmitting, and creating electronic files and data in general leaves many consumers hesitant to trust and use electronic signatures in lieu of handwritten signatures, often creating the impression that electronic signatures are easier to duplicate or forge as compared to traditional handwritten signatures. The nature of electronic documents may also cause consumers to fear that third parties may edit the document after they've signed it, exposing them to fraud. The use of fully electronic, remote, or computer-based systems also introduces different modes of user error and mistake that may arise from misapprehension of user interfaces. The great variance in technical literacy across end users can also lead to confusion or fear of unwitting exposure to traps, mistakes, and the fear of abuse by more technically savvy parties. While the legal requirements of the UETA and E-SIGN Acts are meant to provide safeguards against such hazards, they dictate only the requirements, leaving the details of implementation up to the service provider.

### BRIEF SUMMARY OF THE INVENTION

The present invention overcomes shortfalls in the related art by presenting a unique and unobvious combinations of databases, database uses, server systems and other components to create efficient systems and methods to provide an electronic platform enabling consumers to create a proposed legal instrument, sometime referred to herein as a contract, electronically sign the contract and pass the signed contract on to the next potential signatory. The next potential signatory has the option of expressing their consent to the contract by signing the contract and not making changes or may make changes to the contract and then sign the changed contract. When a contract is changed by a subsequent signer, the prior signer is no longer bound by the prior contract. The prior signer may be presented with an amended contract which they may reject, sign without amendments, or make amendments and then sign. The round-robin nature of the contract amendment process allows for iterative changes to a proposed legal agreement and deal making efficiencies not found in the prior art of negotiating contract terms, and then attempting to reduce the terms to a separate writing.

Each iteration of a proposed contract may be stored in a separate database to memorialize the negotiation process and to facilitate the creation of a final document. A final document may refer to a document signed by all parties. Final documents may be stored in a separate database to ensure the integrity of the document and to aid in the efficient retrieval of the document.

The disclosed embodiments overcome shortfalls in the art by presenting templates and interactive questionnaire systems to seamlessly populate and/or draft legal instruments while authenticating user identities and user subject matter authority. The interview process or questionnaire systems may access, construct and/or populate a plurality databases that may be mapped, coordinated or triangulated to a system user, a purported identity, the contents of a proposed agreement, the subject matter of a proposed agreement or other transactional component.

For example, in constructing a land purchase agreement, a purported seller may enter information regarding the subject property. The system may access country recorder records or other legitimate third party databases obtain property information and property owner information. The use of such outside databases or third party databases allows the disclosed system to verify the authority of a named seller to enter into the proposed transaction. The use or mapping of outside databases also assists in populating proposed contracts. In the present example, the use of county recorder records may confirm that a John Doe does own the subject property.

To verify that John Doe is the person on the system creating the proposed contract, other databases may be accessed. For example, the system may ask for personal information that is known or should be known to John Doe only. By use of multiple external databases, system databases, user input may be mapped or triangulated to verify that a person named John Doe owns the subject property and the consumer on the system purporting to be John Doe really is John Doe. A similar approach may be used to verify the interest and identity of a potential purchaser of the subject property.

Disclosed embodiments include a system and method for drafting, modifying, authenticating, and signing web-based legal contracts and other legal instruments. This invention can be based on or utilize user interface that enables parties to easily create and execute web-based contracts or other legal instruments. By way of an interactive questionnaire or “interview”, an author or authors drafts an initial document by answering a series of questions via the interface, potentially implemented as a series of web forms. The answers to those questions are then used to identify the named parties and desired signatories and key terms of the contract or instrument. The parties/signatories are then contacted, authenticated, and validated through a triangulation of data sources. Each party to be signatory is notified of the contract and reviews, acknowledges, and indicates his or her intention to execute the contract by electronically consenting to accept the terms of the contract. The contract and evidence of consent are saved in a separate electronic database. The contract is deemed executed when all intended signatories have indicated consent to a finalized document. If the author modifies the document at any time after requesting consent from all the signatories, all pending consent is cancelled and consent must be gathered anew. This allows the parties to iterate over the details of the agreement in a convenient fashion while still preventing fraud via unilateral modification.

As noted previously, users' levels of sophistication, degree of technical comfort, and trust of electronic signatures given the perceived ease of forgery and duplication are all barriers to adoption of the use of electronic signatures. Many applications and services that offer electronic signing options also often include opt-out or alternative provisions for the use of fax machines or physical mail-in handwritten signatures to accommodate individuals who do not trust electronic signing or who worry about the integrity of the electronic documents they may be signing relative to the paper documents with which they may be more familiar.

The present invention includes elements that reduce the potential for user error, mistake, or fraud in the drafting and execution of legal contracts by coupling the process of document creation and document execution so as to eliminate a potential disconnect between the named parties of the instrument and the digital signatures to be attached to the document. Many other schemes separate the tasks of document creation and document signing to the extent that the signatures being attached to the document are not guaranteed to be the correct signatories in a legal sense (as opposed to a cryptographic or technical sense). The present invention uses the process of instrument or document creation to define the signatories, such that the signatures to be supplied are identified and associated with the actual parties to the document being created. That is to say, if Party A and Party B are named parties to a contract, for example, then Party A and Party B will be the signatories, unlike a model where a contract may be created with Party A and Party B as the named parties but the system permits the contract to have electronic signatures from Party C and Party D attached instead, resulting in a defective instrument. A more direct relationship between document creation and document signing reduces the incidence of mistake, error, or fraud by enforcing a greater degree of contextual accuracy and fidelity.

The present invention also allows users to more conveniently address the common situation wherein the terms of a legal contract, document, or other instrument requires iterative revisions to correct information, identification, or typographical errors. Typically, online legal document creation services present the ability to create a document or import one from an external source, but if there is a need to modify the document before all parties have indicated their consent to sign, execution is abandoned and the entire process must begin anew. The questionnaire/interview-related process of creation in the present invention maintains a separate, specific data structure that tracks the receipt of pending signatory assent in concert with document version history, such that only the most recent version of a document is capable of potential execution, and pending execution is cancelled and restarted anew whenever it is determined by the author or authors that a modification is necessary. It is useful to be able to arrest or interrupt the process of execution so that the document can be revised without subjecting the participants to duplicative work beyond the need to consent to signing the revised version. Once all signatories have indicated their consent to sign the instrument, further modification is no longer possible. This prevents unilateral modification of an executed contract while providing enough flexibility to the parties to negotiate, correct, or work out the agreement without the cumbersome need to start the entire process of document creation from scratch. It also prevents the document from being executed until each and every signatory has consented to the final revision of the instrument. The data structure that tracks signatory consent definitively withholds execution until total assent is collected and its state can be explicitly displayed on the user interface, which is an improvement over the prior art in that no legally ambiguous or partial execution is possible or can even be represented or passed off to a third party as fully executed.

### BRIEF DESCRIPTION OF THE DRAWINGS

FIG. 1 is a schematic view of system architecture

FIG. 2 is a flow chart

FIG. 3 is a bill of sale interface

FIG. 4 is a continuation of FIG. 3 and includes an interface to accept an electronic signature

FIG. 5 is a continued signature interface and invitation interface for additional signatories

FIG. 6 is a further signature interface

FIG. 7 is an interface inviting another party to sign a document

FIG. 8 is a further interface inviting additional signatures

FIG. 9 is an interface showing the receipt of electronic signatures

FIG. 10 is an interface showing signatures

FIG. 11 is interface allowing for cancellation of an electronic signature

FIG. 12 is a further user interface

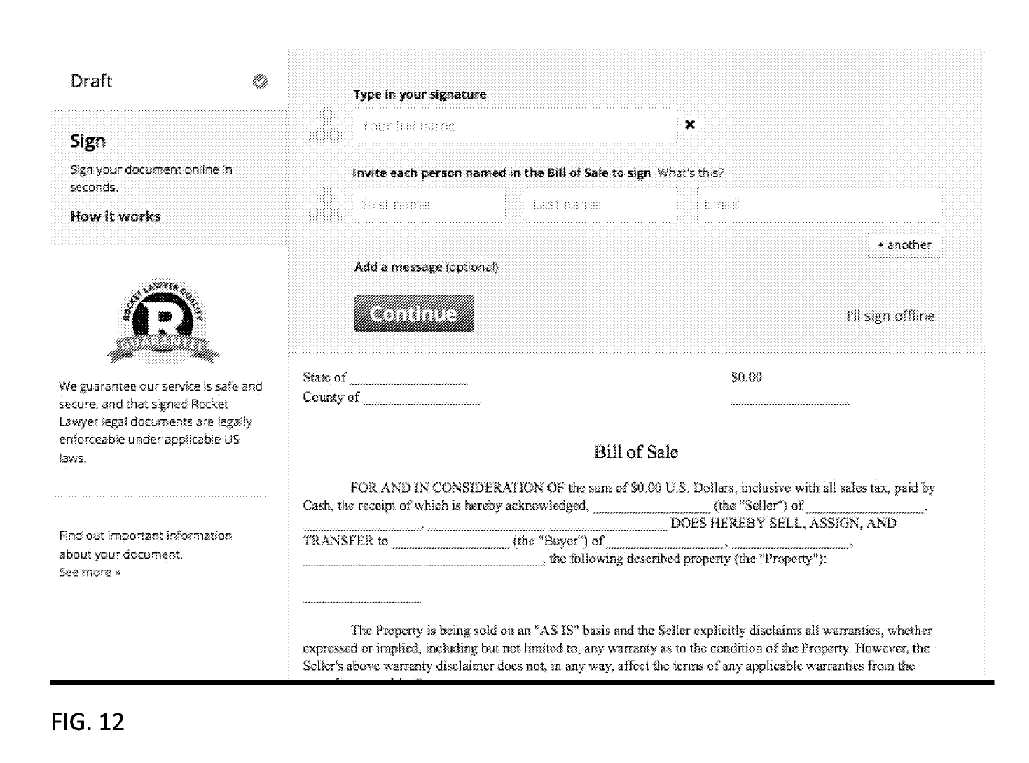

FIG. 13 is a schematic view of system components sometimes used

### REFERENCE NUMERALS IN THE DRAWINGS

101 client endpoint
102 plurality of signatories
103 web page service layer
104 server email service
105 back end business logic
106 user account information
107 document template library
108 document interview library
109 document snapshot/version history
110 document history metadata
111 e-signature request data
112 document signature consent data
130 server architecture area
140 data storage area
200 starting point for document creation
201 select document template step
202 answer interview or answer questions step
203 document eligible for execution decision step
204 notify signatories of version to be executed step
205 Collect assent for execution step
206 document content modified question step
207 cancel and invalidate pending assent step
208 all assent collected question step
209 finalize executed document step
210 executed document complete state
250 control from 203 after a “no” response
255 control from 203 after a yes response
260 control from 206 after a yes response
265 control from 206 after a no response
270 control from 208 after a no response
275 control from 208 after a yes response
300 bill of sale interview interface
310 draft of bill of sale
320 interface to type in a signature
330 interface to invite others to sign a document
340 indicia or a marking denoting a signature or electronic signature 340
350 bill of sale having signed and unsigned area or user interfaces 350
352 information regarding a first recorded signature
355 an interface allowing a second person to sign a bill of sale
357 information regarding a second recorded signature
358 information regarding a third recorded signature
359 information regarding a forth recorded signature
360 a code, scan code, marking or other indicia mapping to information regarding a signed document
400 machine readable instructions
415 non-transitory media or medium capable of retaining machine readable instructions for use with a computer processor
425 a computer processor, general or specialized
430 memory, volatile or static
510 database of templates and/or questionnaires and/or user interfaces
520 database of documents in process
525 database or plurality of third party databases
530 database of completed and executed documents
600 data object or other mechanism tracking pending consent to sign requests and/or document amendments and/or document completion and/or signatory completion

These and other aspects of the present invention will become apparent upon reading the following detailed description in conjunction with the associated drawings.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

While certain aspects of the invention are presented below in certain claim forms, the inventors contemplate the various aspects of the invention in any number of claim forms.

The term “interview” may mean a user interface comprising of a series of one or more forms, similar to standard web forms, that may include one or more radio buttons, check marks, single or multiple selection interfaces, text entry fields, or other interfaces established in usage or literature and presented as answerable questions for the author or authors creating the legal document to be signed. This series of forms is used to collect data which may be used to create a legal contract, document, or other instrument from a document template.

The term “template” may mean a representation of a class of electronic documents, used as a prototype for a legal contract, document, or instrument. Templates are typically presented as many form contracts or documents are in the course of normal business, with entry blanks for specific information. This information, including the names or identities of the involved parties, is also used to identify and contact the signatories to the instrument.

The term “e-sign request” may mean a data object which maintains at least a reference to a specific document-in-progress within the document snapshot or version history data storage, as well as list of all entities (identified by name, identification number, or other identifying information as appropriate to the system) whose consent to sign is required in order to execute the document. The e-sign request data object also maintains an accounting of its own state; at the least, it maintains at least two possible states, including a ‘pending’ state which indicates that there are still pending signatory consents required for receipt before the document may be deemed executed, and a ‘complete’ state which indicates that all consent to sign the document has been received, and that the associated document is therefore considered both final and executed, no longer eligible for further modification within the system.

Technical Background

Disclosed systems may be embodied by an internet and mobile device available hosted service, with user data, commands and actions, display and rendering being implemented on remotely hosted servers and computing resources that use standard internet communications protocols as well as web development frameworks and network architecture stacks. Specific technologies may include Rackspace for remote hosting, HBase and Percona MySQL for data storage, RabbitMQ and protobuf for messaging, Java EE and Spring for services development, and HTML, jQuery, Angular, CSS, and JavaScript for display and page rendering.

Those having skill in the art will appreciate that the specific technologies or providers used for hosting and implementation of backend logic and frontend functionality in this example are merely representative, and that multiple functionally equivalent means and configurations of hosting architectures, server technologies, and programming languages exist. Those having skill in the art will also appreciate that the distinction between different ‘objects’ as represented in data may be enforced by organization, de-sign, physical proximity, or any combination of the above.

For example, the storage of document snapshot data and e-sign request object data may be in close physical proximity on a cloud-hosted service, but are nevertheless distinct and separated from each other by the architectural and backend de-sign, such that in practice the objects are isolated from each other by access and storage. Alternatively, the two could be physically separated as well, with one being stored in an indexed key-value, nonrelational storage space, and the other located as an entry or structured collection of entries in a relational database, with their association enforced by code conventions and attribution data relating to a separate object, such as user profile data. In each case, the computer system in the invention recognizes them as being distinct, though associated or related, through application programming interfaces (APIs), identity keys or relational or index data, or other methods for associating data known in the art.

Further Description

Disclosed embodiments include methods and systems for creating and executing legal instruments, including one or more authors and one or more involved parties, one of whom is the document author. Involved parties are also signatories to the agreement, and the document will be considered executed when and only when all signatories have consented to sign the document. While each signatory consents to sign the document over time, individual consent is not applied to the document itself, but stored in a separate location or database along with a data object which tracks the pending requests and receipt of consent to sign from each intended signatory. Once consent is obtained from all intended signatories, the data object which tracks pending consent is deemed complete and it along with the document itself is deemed an executed legal instrument. For the sake of brevity, any legal contract, instrument, or document requiring signatures for execution may, for the purposes of this disclosure, be collectively referred to as a “document”.

One of skill in the art will appreciate that although an embodiment of the invention described herein is made with reference to a system configured to operate over the Internet, served by a host system configured to be accessible over the World Wide Web (“WWW”) by way of Uniform Resource Locators (“URL”) via Hypertext Transfer Protocol (“HTML”), embodiments may be configured to be deployed over one or more network architectures, including private intranets, mobile devices over wireless communications, through tablets and smartphones, via e-mail delivery, or any network-connected device using the appropriate rendering devices, browsers, and served by appropriate data stores or databases.

One embodiment of the invention may be implemented through a server and client architecture implementing the services, as is typical for many e-commerce and web applications provided over the Internet or within a private or company intranet.

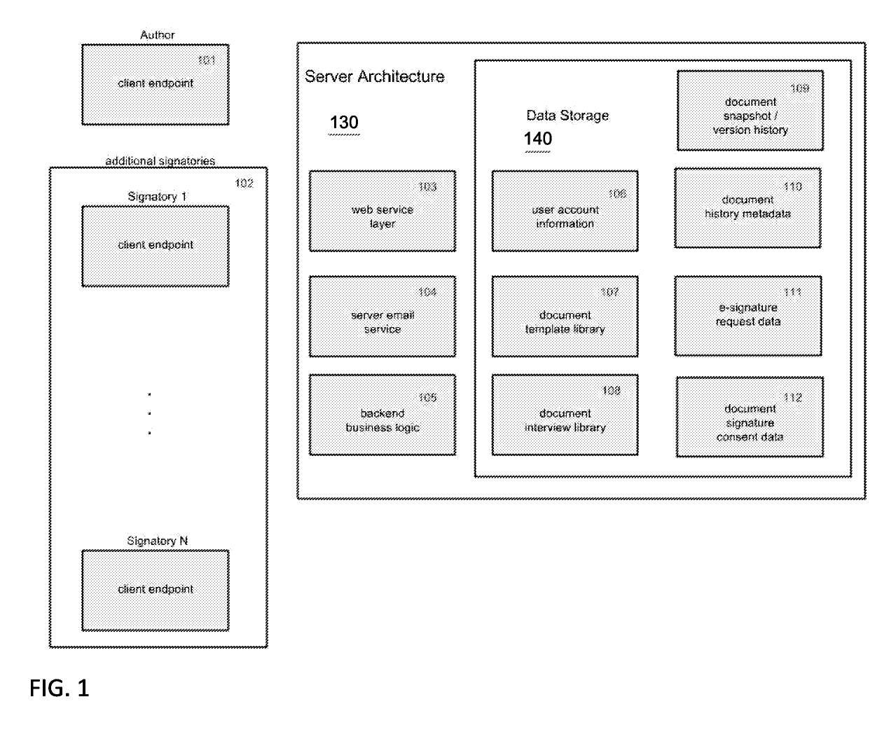

Referring to FIG. 1, a document author interacts with the system via client endpoint 101, which may be any input and display device capable of interacting with the system over any appropriate communications network, such as a phone or wireless telecommunications network, the internet, or direct network. In the disclosed embodiments, this is assumed to be a computer, laptop, mobile device, terminal, or other device capable of sending and receiving messages and requests with the rest of the system through a designed or configured URL/URI interface. In a disclosed embodiment, the client endpoint is also assumed to be able to provide access to email services via a web browser, though one of skill in the art understands that messaging over the communications network in other embodiments can take other well-established forms besides email.

While some documents such as oaths, deeds, or declarations may require only a single signature to be executed, many other types of documents, such as contracts and agreements involve more than one party, and so additional signatories will potentially interact with the system through their own client endpoints 102. It is entirely possible that there may be partial or total overlap between client endpoints 101 and 102, as the author or various signatories may choose to share a device in order to work on a document together. In cases of shared client endpoints, it should be noted that, as is standard with many web or ecommerce services, each individual user accesses the rest of the system from an endpoint through the user of an associated individual user account, data concerning which is stored in user account information storage 106. Access to the system to perform registration and other actions via a client endpoint in the present embodiment is accomplished through the request for and establishment of a user account which is protected via a standard challenge-response authentication system, typically the use of password-protected accounts.

A disclosed document creation and execution system is further implemented through a server computer architecture that includes persistent data storage as well as business logic to analyze and serve user requests. The architecture includes web service layer 103, which receives and sends messages via relevant protocols, such as HTTP and TCP/IP, constructed by the system backend over the communications network with client endpoints 101, 102 with messages passed between them by any means or combination of methods known to those in the art capable of accomplishing such interactions, including, but not limited to REST APIs, structured URL/URI requests, structured data representations such as the JSON format, Ajax calls, and HTML or text files.

The server architecture may include server email service 104, which in a disclosed embodiment is used to send notifications and signature consent requests to the parties to the document; one having skill in the art will recognize that in other embodiments, this service may be provided by a third party or eliminated entirely through the use of an alternative notification or messaging means, depending on the implementation. A disclosed system may also include backend business logic 105, which represents most of the non-user-facing control and decision-making logic embodied in the overall computer system, including arranging and orchestrating user workflows, maintenance and analysis, login and authentication, and other functions useful to the operation of the system.

Referring to FIG. 1, the system also contains data storage means with a number of organizationally identifiable categories of data. The data objects may be represented in a number of ways that will be evident to one having skill in the art, including structured data objects, relational database table entries, proprietary data formats or binary representations of programming language constructs. The system includes at least user account information 106, necessary to identify individual users, provide authentication, or store user-related information, and as a means of associating the ownership or attribution of other data, such as signatory consent and document authorship or ownership to specific individual users. The system also includes document template library 107, which contains prototype form documents with entry spaces available for insertion of information.

For example, a template for a contract between two parties may contain entry blanks for two or more parties, one or more date or price fields and a descriptive text area. Such a generic template may be used as the basis for various contracts between two or more parties. Whether through the business logic layer 105 or as part of the characteristic data stored in document template library 107 or document interview library 108, each document template is associated with one or more document interview representations in document interview library 108. The document interview representations are used by the business logic later 105 and web service layers 103 to present the interview to the document author, through with the author communicates with the system and provides, either progressively or in entirety, the data needed to produce a legally executable document.

Once an author starts working on a document, a snapshot representing the current state of the document-in-progress is stored in a separate area or database, document snapshot/version history 109. The document templates 107 are merely prototypes; representations of documents-in-progress are created by a combination of data from a document template, whether a literal copy of it, a condensed summary of user-supplied data with a template identifier, or other intermediate representation, is stored as an entity separate and distinct from the original template and other documents-in-progress based on the same template. Snapshots in the present embodiment are read-only once stored in 109; should the document author or other party authorized to work on the document-in-progress wish to make alterations, the result is saved as a separate snapshot in the document snapshot/version history 109. A document that has been created and undergone two revisions, for instance, would have three different snapshots stored in version history 109, one for each separate version.

Metadata regarding document snapshots, which may include bookkeeping information such as time of creation, is stored in document history metadata 110, and are created and associated with individual snapshots in the document snapshot/version history 109. In the present embodiment, document history metadata 110 is located in a separate location from the document snapshot/version history and organized in separate data objects, but this is not a strict necessity. Metadata may be directly attached or stored in conjunction with document snapshots if desired for operational or performance reasons.

In some embodiments, the system may allow the user to save their work and return to the interview at various times, in others it may require the user to fully answer the interview in order to establish an initial version of the instrument. In either case, the interview may continue, depending on the specifics of implementation, in a linear, cyclic, or freely navigable (as in the present embodiment) fashion until all required fields, including identification of all the parties/signatories to the instrument, have been completed. In the present embodiment, the identity of the intended signatory must include said intended signatory's email address. The system may save document ‘snapshots’ in the document version history 109 along the way, following the same rules as above. Once the interview questions have been answered to place the document in a state sufficient for execution—including at least the identification of the named parties/signatories, the system saves a snapshot of the document in the document version history 109 and also creates and stores an e-sign request object associated with that document snapshot in e-signature request data storage 111.

e-signature request data may be stored in its own area of data storage 111 or database. In contrast to document history metadata, an enabled e-signature request data object is not necessarily created for every snapshot. An e-signature request data object records, at the very least, an identifier sufficient to associate it with a specific document snapshot, a state variable that indicates whether the e-signature request has been started, pending, or is complete (it may have other state as required in specific implementations), and tracking information that indicates the number and identities of the required signatories. Only a document snapshot that is capable of being executed (i.e. specifically identifies the minimum number of signatories required for document execution) has an enabled e-signature request data object created, associated with it, and stored in 111. An enabled e-signature request data object is one that is initially created in a starting and/or pending state, awaiting the recordation of signatory consent needed in order to fully execute the document associated with it, and can reach a completed state once all such consent arrives. By contrast, an e-signature request that is disabled, whether initially created as such or becomes disabled when its associated snapshot is superseded by another version of the same document-in-progress, does not accept additional signatory consent, nor can it be used in conjunction with its snapshot to result in a fully executed document. Once an e-signature request becomes disabled, it may not become enabled again. In the present embodiment, an e-signature request data object is simply not created for a document snapshot that does not identify the minimum number of signatories for execution of this document type or satisfy all other requirements for execution, rather it is created only when a snapshot presents sufficient information to produce a valid, executable document.

When an identified signatory consents to sign an executable document, their assent is recorded as a data object within the document signature consent data storage 112. Consent data is recorded with reference to a specific user (the signatory) as well as a specific e-sign request and/or snapshot, such that each consent to sign is unique to that specific combination of user, document snapshot, and e-sign request, and may contribute to the requirements for execution of that document snapshot only.

The system deems and designates a document as having been fully executed when the most recent snapshot of the document-in-progress is associated with an e-sign request data object and when consent to sign is received from all identified signatories identifiable by the e-sign request data object. With the arrival and recordation of all required consent the e-sign request data object is affirmatively marked as being ‘complete’ by having a status variable set accordingly. Signatory consent to sign is thereafter deemed to be an actual signature, not merely consent to sign, and renderings of this signature on this completed document are given legal force. This collection of these specific data objects in these specific states completes an executed document within the system.

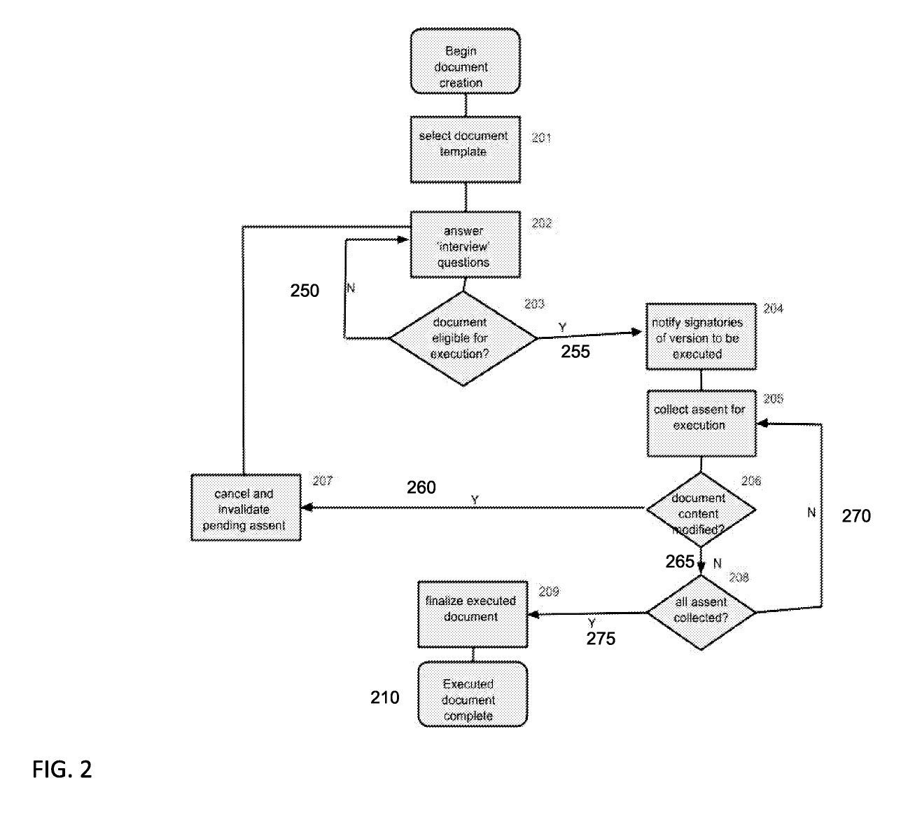

FIG. 2 and subsequent figures provide an example of document creation work flow and related processes. FIG. 2 depicts the document creation and execution workflow in the present embodiment. The user first authenticates themselves on the server system by supplying authentication and user account information from his client endpoint 101, sending a message to the server via its web service layer 103. On the provision of the correct user credentials, the system identifies authenticates the user by logging the user on after sufficient credentials are received as governed by the information stored in user account information 106. The process of creating and executing a document begins when the author elects to create a legal document. The author indicates to the system what kind of legal document he wishes to create, and the system logic responds by locating the template for the desired document. The system then presents an interview associated with that template and presents it to the user. A user begins at step 201 by communicating with the system through their client interface 101, communicating to the system by sending a message to it through a communications network to be received via web service layer 103 and selecting a document type for creation. The business logic 105 identifies the document template and document interview from 107 and 108, respectively, assembling it and any other required information for data transmission back to the author through web service layer 103. The author receives the data at his client endpoint 101, which renders the beginning of the interview process as a frontend user interface.

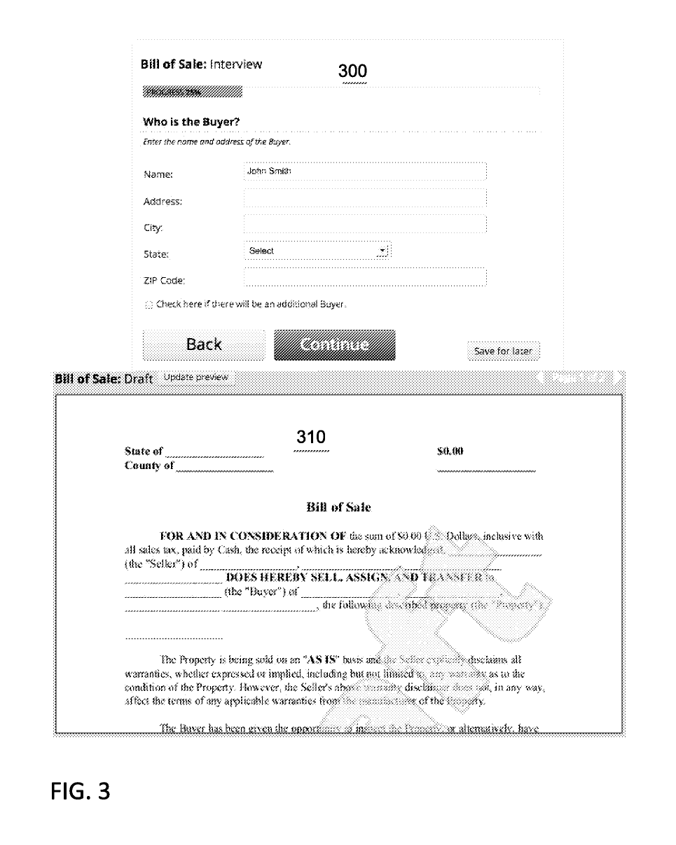

An example of the frontend view of such an interview process is illustrated in FIG. 3, which depicts an example interview interface for collecting information needed to create a “Bill of Sale” legal document. FIG. 3 also shows an optional modification to the invention, wherein the document-in-progress is visually rendered as a “draft” document where user information is used to fill in the document blanks to illustrate to the author what the document may look like in print. While not an essential part of the invention, this feature provides visual feedback of progress to the author and helps him understand the document's state of progressive completion.

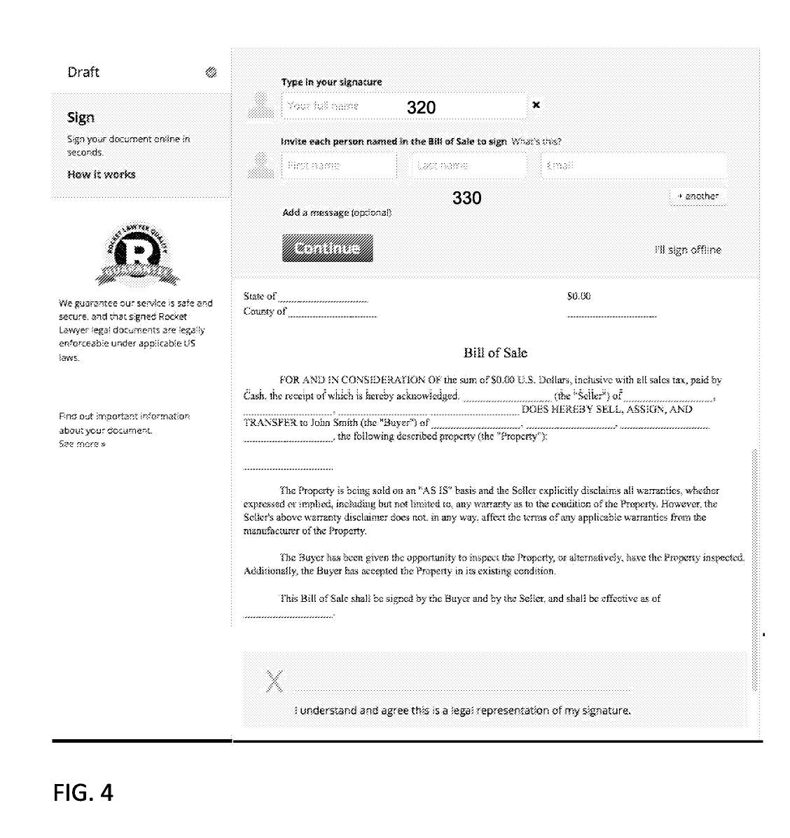

FIG. 4 illustrates the same document interview at a stage wherein the author is being asked to specify identifying and contact information for the parties whose signatures are required to fully execute the document.

Those having skill in the art will recognize such a guided questionnaire experience as being familiar in web applications, consisting of a series of one of more web forms rendered by a browser using frontend code, and know that the forms may consist of a variety of question and response gathering elements such as radio buttons, check boxes, selection interfaces, and text boxes accompanied by instructions, explanations, help text, and a submission interface. The progression of the interview is governed by the document interview previously selected from data storage 108 in step 201.

In steps 202 and 203, a series of messages and requests back and forth between the server and client endpoint in this fashion implements the front-end representation of the document interview and collects the user's answers to the interview. Web service layer 103 presents interviews via messages to client endpoint 101 as a series of question-and-answer forms for the author to use to supply information needed to complete the document and identify the named parties as signatories to document. The user's answers to the document are communicated back to the server by sending messages from client endpoint 101 back to web service layer 103, via use of a web-based application programming interface where they are received by the server architecture. The user may, depending on the implementation, be free to use the interview in strict sequential order, or as a working ‘document’ wherein he may revise the information being used to populate the template.

As the author works their way through the interview in the process described above, the contents of the interview to be applied to the working document-in-progress are stored in snapshot data storage 109 using the document template as an example and guide, in space reserved for document snapshots as a version history. In the version history, the contents of the document-in-progress are stored, creating a traceable history of modifications and progress, with all the information needed to recreate the state of the document in each of its saved revisions. Document snapshots are created and recorded and stored, but never thereafter edited; new revisions result in new snapshots.

In conjunction with each document snapshot so created in the version history, document history metadata is stored contemporaneously in document history metadata storage 110; this metadata includes information such as the timestamps of revision and other bookkeeping data that provide the external historical context and record of revisions made to the document that do not reside within the document itself. While this information is separate from the document itself, one having skill in the art will appreciate that the storage of this information may be implemented in a variety of ways. So long as there is a referential, relational, or other identity-based association of the document history metadata with the document snapshot, their actual storage in proximity can vary from one implementation to the next. They may, for example, be located in the same relational database, one or both may be stored in an index or key-value store, and the systems storing each may be located in the same data storage structure or located in separate locations, servers or even processed by different data storage mechanisms and structures communicating with one another via a message system, interface, abstraction, or API. The creation of snapshots and snapshot metadata concludes a single iteration of step 202. The previously selected document template and accompanying interview define which pieces of information are mandatory or required in order to make the resulting document eligible for execution.

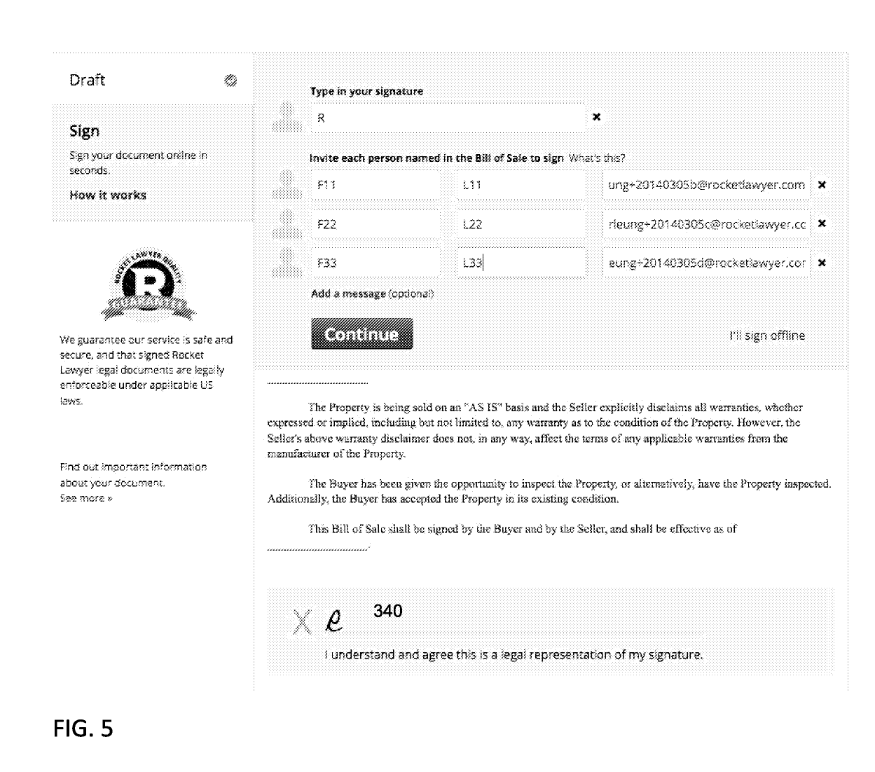

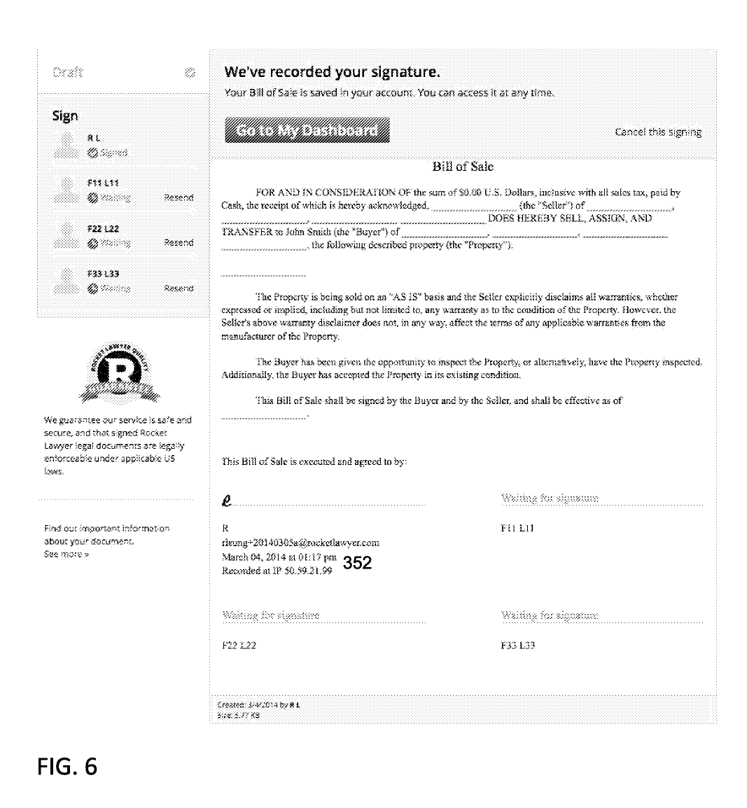

FIG. 5, for example, illustrates a point in an interview wherein the author is specifying the identities and contact information of the parties whose signatures are needed for document execution. The document template and interview indicate what fields are required in order to render the document suitable for execution, but in the present invention this always includes at least the specification of the desired signatories. If the document is not yet fit for execution, the work flow returns to step 202. If, at step 203, the document snapshot is eligible for execution when it is saved to storage, an associated “e-sign request” bookkeeping data object is created and saved in a separate signature metadata storage 111, associated with the snapshot just saved. Each e-sign request object is unique to a given snapshot. Once the e-sign request data object is created, the system sends notifications to any other additional signatories required, taking the work flow to step 204. In the present embodiment, this notification is delivered via email, via the system's email service 104. The document snapshot, metadata, and e-sign request data are now await the consent of all signatories to accomplish document execution, as illustrated by the “Bill of Sale” example in progression from FIG. 5 to FIG. 6, which depicts an instance wherein the author, by creating the document, inherently consents to signing, and wherein the document awaits the consent to sign by three other users in order to fully execute the document.

At this stage, the snapshot is in an unexecuted state, but eligible for execution and awaiting each intended signatory's consent to sign the instrument. The present embodiment notifies each intended signatory via email, and waits for them to provide consent.

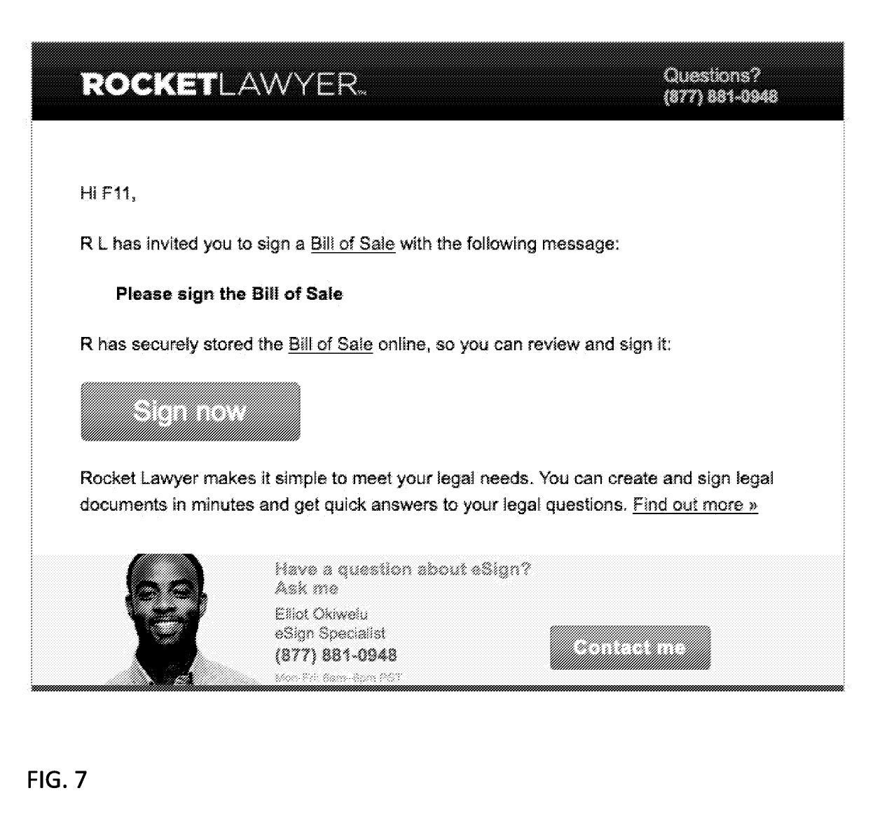

An example of an HTML-encoded email sent in step 204 requesting a given signatory's consent to sign the document is illustrated in FIG. 7.

The link in such an email will be associated to a particular snapshot/e-sign request combination; in the present embodiment, a unique identifier is created for each such link, associating it with a specific intended signatory and document snapshot/e-sign request pairing. The backend control logic and data stores ensure that the notification can only be used for that specific request and no other. In the present embodiment, when the intended signatory follows the link or other forwarding mechanism in the email notification, it directs his client endpoint's 102 browser or similar interface means to send a message via REST API to the server architecture for receipt by web service layer 103. One having skill in the art will recognize that this step may be achieved by equivalent means using other encoding, messaging, or transmission schemes and protocols. The invention is not intended to be limited to the use of email alone as a notification method; text messages, chat messages, dedicated client software, and other means are well-known to those having skill in the art.

After notifications are sent, the work flow is at step 205, pending the receipt of signatory consent or other action by the author on the system. If the author attempts to modify the document at any time before the document receives all the consent necessary for execution, this is detected at step 206 in the work flow, the workflow proceeds to step 207, which creates a new snapshot for the modified document and new bookkeeping metadata for the newly created snapshot to be stored in 109 and 110 respectively, just as it would be at the conclusion of an iteration of step 202. The previous snapshot is not deleted, but it is no longer current, and the e-sign request data object associated with it is invalidated by having its characteristics set to a cancelled state. This is one way that an e-sign request can be placed in a cancelled state.

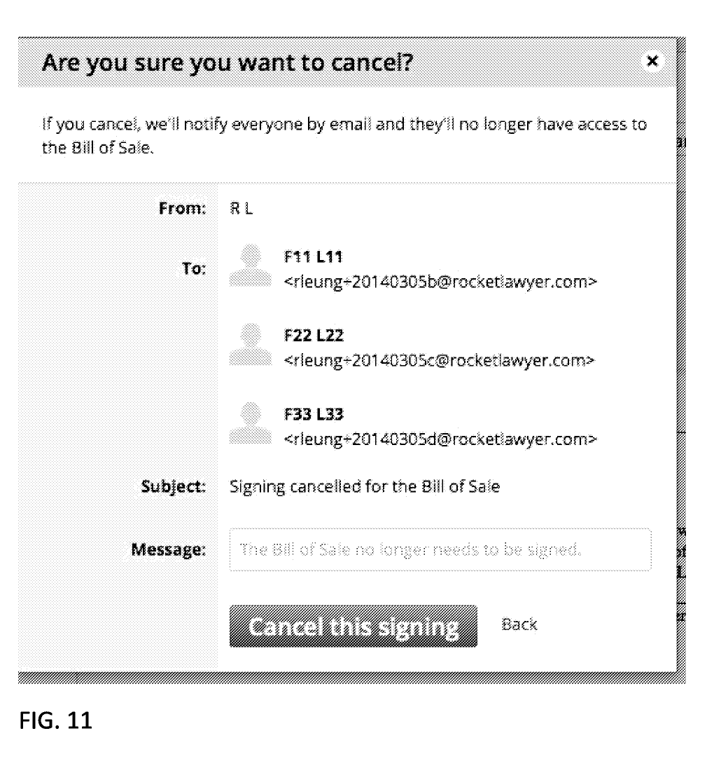

Another is for the author to cancel the entire document-in-progress as illustrated by an optional implementation of a document cancellation feature whose interface is illustrated in FIG. 11, which will send a message from the client endpoint to the server system to mark the most recent snapshot as invalid and place the e-sign request object associated with it stored in 111 in an invalidated state. Whatever consent to sign may have been stored in 112 associated with the snapshot/e-sign request pair will thereafter never be made operative.

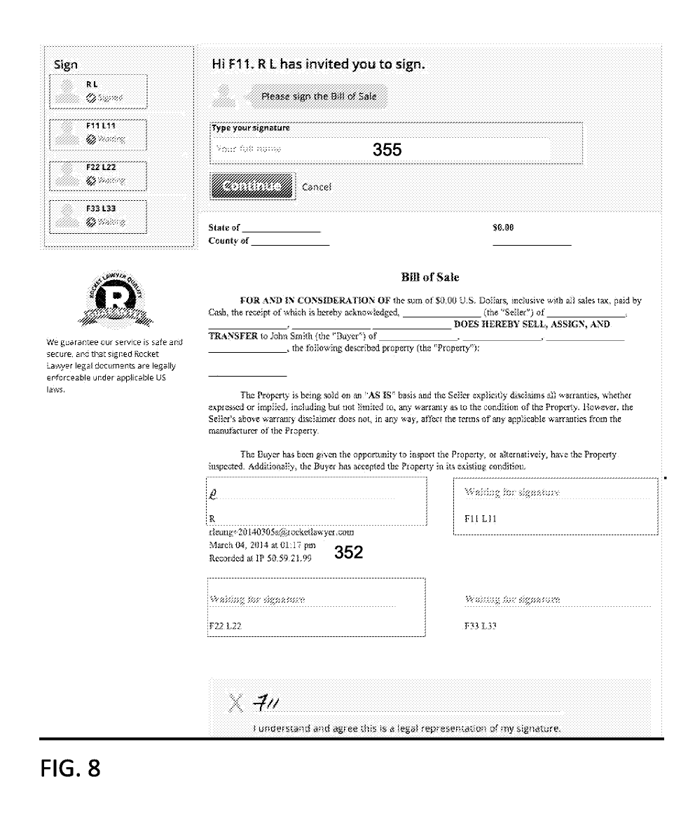

Absent authorial modification, the work flow loops from steps 205, 206, and 207 and back to step 205, awaiting consent from all signatories as described herein. As per step 204 and the illustration of FIG. 7, each intended signatory is sent a notification via email to consent to signing the document. Once the server receives at web service layer 103 the message resulting from the intended signatory, the backend business logic 105 processes the request and checks to see whether the e-sign request/snapshot pairing associated with that notification is still valid for execution. If the e-sign request is still in a valid state when the intended signatory responds to that notification, the server responds to the user by sending a message back to his client endpoint 102 from web service layer 103. If the user is not logged in, the message sent from web service layer 103 to the client endpoint corresponds to a login and registration page, wherein the intended signatory may authenticate himself to the system, or create an account and identity on the system, as an entry in user account information 106 is required to complete the creation of the entry in the document signature consent data 112 needed to indicate consent to sign the document. If or once the user is logged in and the e-sign request is in a valid state pending execution, the message contains rendering information for an interface requesting his consent to sign the document, as per FIG. 8, which requests his consent by typing his full name. If the e-sign request is not in a valid state, due to an authorial modification of the intended document or other eventuality, the information returned to the intended signatory by business logic 105 and web service layer 103 will indicate that the notification and request for consent is not valid as to the snapshot and e-sign request object for which the notification was sent.

FIG. 8 illustrates a possible implementation of the user interface that indicates to the signatory the names of the other intended signatories and whether their respective consent to sign the document is pending or has already been received. When the user fills out the field with his full name and submits the form, his client interface 102 sends a message encoding that information, via structured URL and parameters, a REST API, an Ajax request, or other means of messaging, to the server's web service layer 103. Business logic layer 105 receives this request and, if the e-sign request associated with the notification is still valid and pending consent, this user's instance of consent is created as a data object containing information indicating an identifier for this user account as maintained within user account information 106, and further associated with the e-sign request associated with that notification and document snapshot, the whole stored within or by relation to document signature consent data storage 112. Each consent to sign is associated with the particular user and intended signatory who just indicated his consent, a specific e-sign request object, and hence with a specific snapshot, and may be applied and registered to that and only that structure.

Once this consent to sign the document-in-progress is stored in document signature consent data 112, the server system sends a message back to the consenting signatory's client endpoint 102 via web service layer 103.

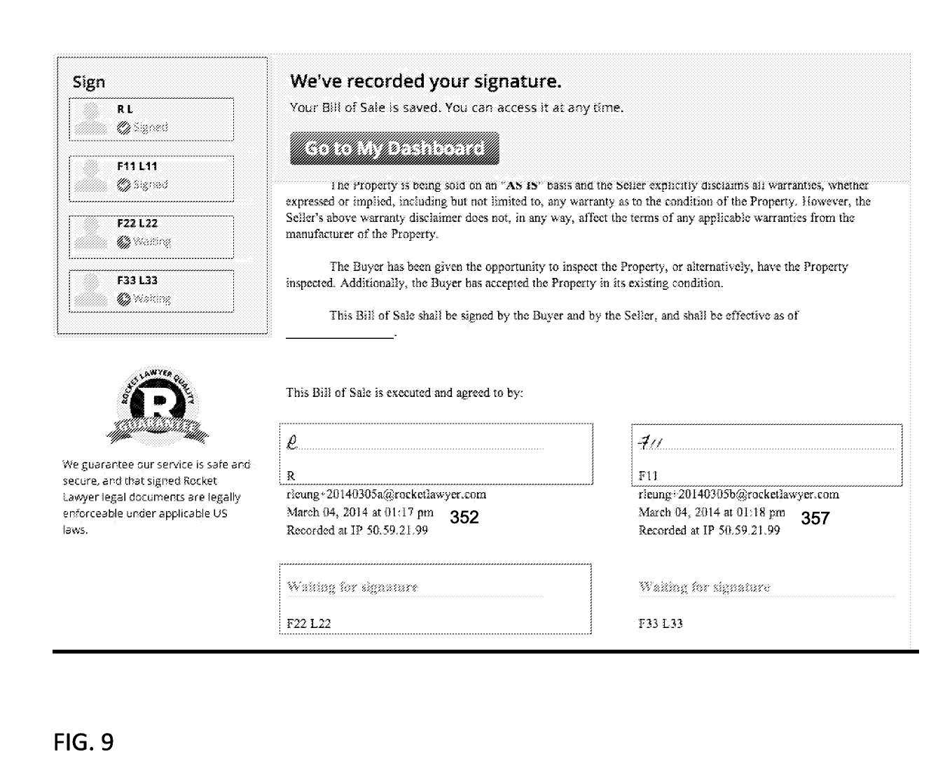

FIG. 9 illustrates a sample embodiment wherein the signatory, in this case, one of three signatories whose consent is required to execute the document, has arrived on the server site (registering an account if necessary for access) and has provided his consent to sign the document. Although FIG. 9 illustrates the case where the first additional named signatory has finished providing their consent, the intended signatories are free to independently provide their consent in any order; sequential consent in time in any particular order is not required.

If there is still consent pending collection at step 208, the work flow returns to step 205, awaiting additional consent to sign from other pending signatories. Document modification during this time by the author or any other authorized party, if any, which will cancel the execution process for this snapshot and move the work flow to step 207 as described above, creating a new document snapshot/version history entry in data storage 109. This new snapshot, being more recent than the previous snapshot, supersedes the previous version. The previous version is not altered or removed; instead, new document metadata is created that identifies the newly-created snapshot as the present version and indicates at all times and queries to the business logic that it is now the present snapshot. Because the existing e-sign request data object in 111 and any associated signature consent metadata in 112 are all associated with the previous snapshot, they too become invalid; in some implementations, the e-sign request object may be altered to reflect its cancelled or abandoned state, but this can be handled either by such explicit representation or inferentially by business logic, based on implementation preferences and circumstance as determined by those having skill in the art. If the newly-created document snapshot is eligible for execution, a new e-sign request data object is created, associated with the newly-created snapshot, and the process for notifying and receiving consent from the indicated parties/signatories above begins anew. If the newly-created document snapshot is no longer eligible for execution after the edits made to it, no e-sign request data object is created and no potential signatories are notified or offered the opportunity to indicate consent. The work flow will again loop unless and until the author revises the instrument-in-progress to once again reach a potentially executable state.

It is important to note that the progressive receipt of consent does not result in progressive execution. The document is not executed until all consent is received, and while a sample ‘signature’ may be rendered on draft copies of the document, these are not deemed part of an ‘executed’ document until the e-sign request status is ‘complete’. Only once the e-sign request data object is marked ‘complete’ after the receipt of all pending consent is the consent applied to fulfill the execution of the document by reclassifying the indicated electronic consent into applied electronic signatures.

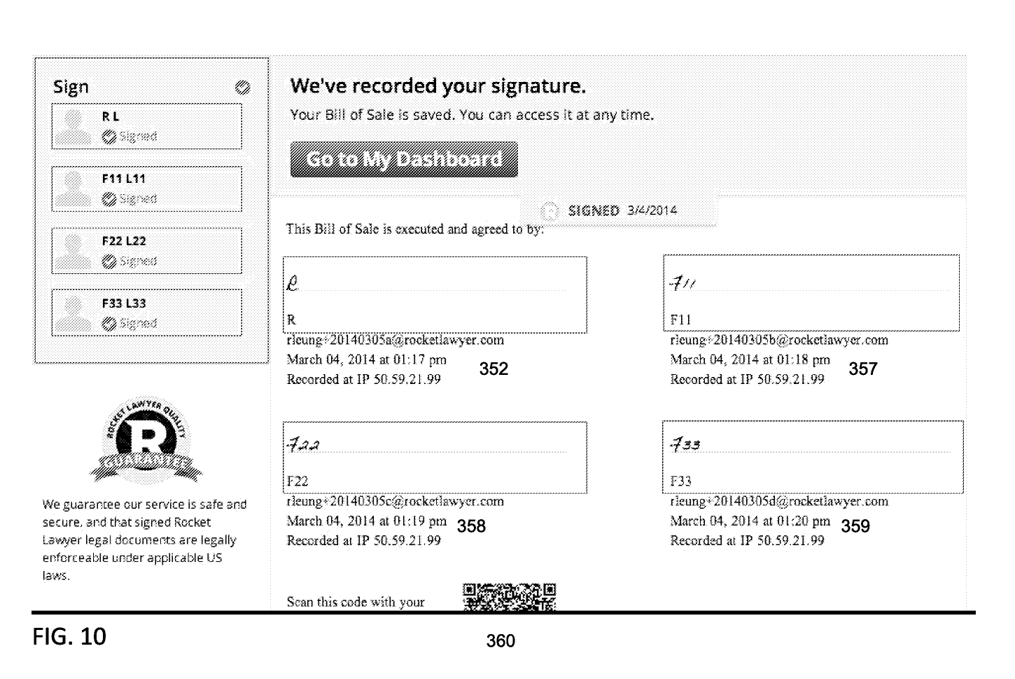

If, at step 208, if, after storage of this user's consent information in document signature, all pending consent to sign has been received and corresponding signature consent data relating to this document snapshot/e-sign request pairing has been received and stored in 112, the e-sign request for this snapshot is accessed in data storage 111 and state modified to reflect a completed status. This result is communicated via a message from web service layer 103 to client endpoint 102 to render a preview of the executed document as Illustrated in FIG. 10, where all signatories are listed as having signed the document. At this stage, the business logic layer forbids further document modification, making this snapshot and e-sign request final, and all signatories' consents to sign are simultaneously engaged as legally operative signatures, resulting in a fully executed document no longer subject to unilateral modification.

The snapshot, completed e-sign request object, and collection of document signature metadata are collectively finalized, creating a fully executed legal instrument. Once this is accomplished, the instrument is no longer subject to modification of any kind by any signatory or author. The instrument is no longer subject to editing, and the signatures are not subject to revocation.

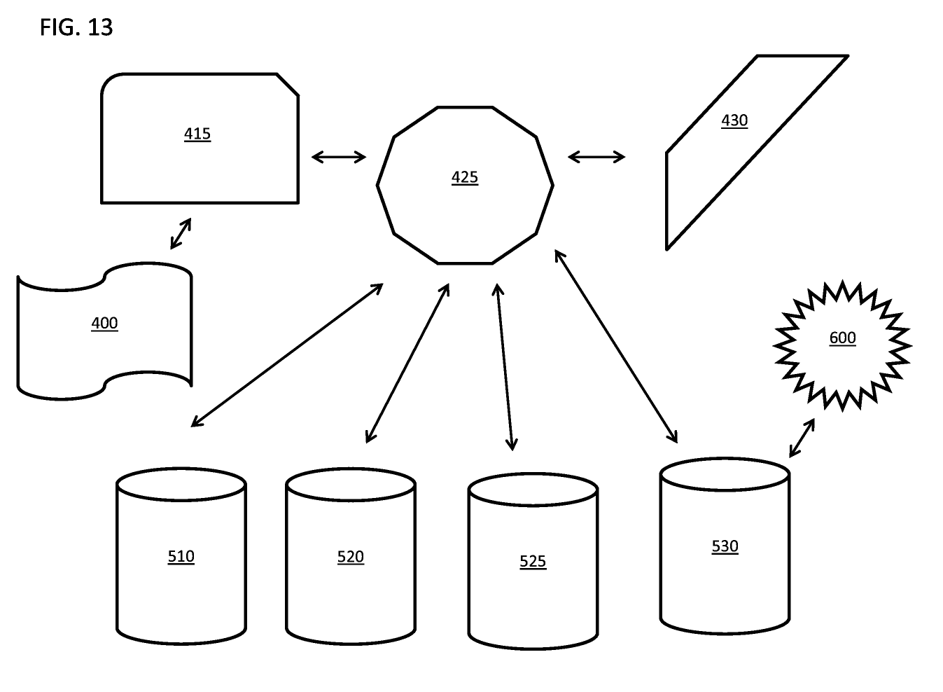

FIG. 13 depicts a disclosed embodiment comprising machine readable instructions 415, the machine readable instructions may direct the processor 425 and/or plurality of databases and/or other components to carry out the goals of the disclosed embodiments. The machine readable instructions 400 may be stored or written upon a non-transitory media or medium 415. The media 415 may be read by a computer processor 425 or other system component. Volatile or persistent memory 430 may be in communication with the computer processor.

The machine readable instructions 400, media 415, computer processor 425, memory 430 and other disclosed components and/or other components know to those skilled in the art may comprise a system server. A system server may be in communication with a plurality of databases, such databases may include a database 510 of templates and/or questionnaires and/or user interfaces, a database of documents in process or documents undergoing revisions and/or signatures, a third party database 525 or plurality of third party databases, a database of completed and fully executed documents and other databases as described, referenced or alluded to herein or otherwise know to those skilled in the art.

The tracking or recording of current document amendments and pending signature requests may be recorded upon a data object 600 or other mechanism, and may be in communication with any of the databases or the server. Upon the data object being an a finished state, wherein all parties have signed the exact same document, a document may be deem completed and stored within a database, such as the database 530 of executed and completed documents.

Disclosed embodiments may include the following items.

Item 1. A computer implemented system for creating, editing and electronically signing documents, identity verification and round-robin amendment and resigning of documents and storage of fully signed documents, the system comprising:

a server system comprising machine readable instructions contained within non-transitory media and a computer processor in communication with the non-transitory media and memory;

the server system in communication with a plurality of databases and a network;

the machine readable instructions directing the server system to produce a first user interface that presents document templates and user questionnaires, with the first user interface accepting data and an electronic signature from a first user and transmitting the data and electronic signature to a document production database, the input creating a document in progress;

the machine readable instructions and the data within the document production database directing the server to produce a second user interface that accepts document revisions and electronic signatures to the document in progress from a second user;

upon a first user and the second user signing the same version of a document in progress, the document in progress is deemed a completed document and stored within a database of completed documents;

upon the second user entering document revisions and signing the amended document in progress, the amended document in progress is presented to the first user, the first user may sign the presented document without entering amendments, in which case the document in progress is deemed a completed document, alternatively the first user may enter additional amendments and resign the document in progress, wherein the document in progress is presented to the second user.

Item 2. The system of item 1 wherein signing of a document includes verification of the purported identity of the first and second user.

Item 3. The system of item 1 wherein the creation of a document includes accessing a third party database to authenticate the claimed identity of the first and second user.

Item 4. The system of Item 1 wherein the creation of a document includes accessing a third party database to verify that a user as an ownership interest in property subject to a document in progress.

Item 5. The system of Item 1 wherein a data object records the state of a document in progress and wherein if all signatories to a document sign the same version of a document, the state of the data object changes, the change being read by the computer processor and the computer processor directing the document to a database of completed documents.

Item 6. A computer implemented method for creating, editing and electronically signing documents, identity verification and round-robin amendment and resigning of documents and storage of fully signed documents, the method comprising the steps of:

using a server system comprising machine readable instructions contained within non-transitory media and a computer processor in communication with the non-transitory media and memory;

using the server system in communication with a plurality of databases and a network;

using the machine readable instructions to direct the server system to produce a first user interface that presents document templates and user questionnaires, with the first user interface accepting data and an electronic signatures from a first user and transmitting the data and electronic signature to a document production database, the input creating a document in progress;

using the machine readable instructions and the data within the document production database to direct the server to produce a second user interface that accepts document revisions and an electronic signature to the document in progress from a second user;

upon a first user and the second user signing the same version of a document in progress, the document in progress is deemed a completed document and stored within a database of completed documents;

upon the second user entering document revisions and signing the amended document in progress, the amended document in progress is presented to the first user, the first user may sign the presented document without making amendments, in which case the document in progress is deemed a completed document, alternatively the first user may enter additional amendments and resign the document in progress, wherein the document in progress is presented to the second user.

Item 7. The method of Item 6 including the step of authenticating the claimed identities of the first and second users.

Item 8. The method of item 6 including the step of using a third party database to authenticate the claimed identities of the first and second users.

Item 9. The method of item 6 including the step of using a third party database to verify an ownership interest of the first or second user of property subject to a document in progress.

What is claimed is:

1. A computer implemented system for creating, editing and electronically signing documents, identity verification and round-robin amendment and resigning of documents and storage of fully signed documents, the system comprising:
a) a server system comprising machine readable instructions contained within non-transitory media and a computer processor in communication with the non-transitory media and memory;
b) the server system in communication with a plurality of databases and a network;
c) the machine readable instructions directing the server system to produce a first user interface that presents document templates and user questionnaires, with the first user interface accepting data and an electronic signature from a first user and transmitting the data and electronic signature to a document production database, the input creating a document in progress;
d) the machine readable instructions and the data within the document production database directing the server to produce a second user interface that accepts document revisions and electronic signatures to the document in progress from a second user;
e) upon a first user and the second user signing the same version of a document in progress, the document in progress is deemed a completed document and stored within a database of completed documents;
f) upon the second user entering document revisions and signing the amended document in progress, the amended document in progress is presented to the first user, the first user may sign the presented document without entering amendments, in which case the document in progress is deemed a completed document, alternatively the first user may enter additional amendments and resign the document in progress, wherein the document in progress is presented to the second user.

2. The system of claim 1 wherein signing of a document includes verification of the purported identity of the first and second user.

3. The system of claim 1 wherein the creation of a document includes accessing a third party database to authenticate the claimed identity of the first and second user.

4. The system of claim 1 wherein the creation of a document includes accessing a third party database to verify that a user as an ownership interest in property subject to a document in progress.

5. The system of claim 1 wherein a data object records the state of a document in progress and wherein if all signatories to a document sign the same version of a document, the state of the data object changes, the change being read by the computer processor and the computer processor directing the document to a database of completed documents.

6. A computer implemented method for creating, editing and electronically signing documents, identity verification and round-robin amendment and resigning of documents and storage of fully signed documents, the method comprising the steps of:
a) using a server system comprising machine readable instructions contained within non-transitory media and a computer processor in communication with the non-transitory media and memory;
b) using the server system in communication with a plurality of databases and a network;
c) using the machine readable instructions to direct the server system to produce a first user interface that presents document templates and user questionnaires, with the first user interface accepting data and an electronic signatures from a first user and transmitting the data and electronic signature to a document production database, the input creating a document in progress;
d) using the machine readable instructions and the data within the document production database to direct the server to produce a second user interface that accepts document revisions and an electronic signature to the document in progress from a second user;
e) upon a first user and the second user signing the same version of a document in progress, the document in progress is deemed a completed document and stored within a database of completed documents;
f) upon the second user entering document revisions and signing the amended document in progress, the amended document in progress is presented to the first user, the first user may sign the presented document without making amendments, in which case the document in progress is deemed a completed document, alternatively the first user may enter additional amendments and resign the document in progress, wherein the document in progress is presented to the second user.

7. The method of claim 6 including the step of authenticating the claimed identities of the first and second users.

8. The method of claim 6 including the step of using a third party database to authenticate the claimed identities of the first and second users.

9. The method of claim 6 including the step of using a third party database to verify an ownership interest of the first or second user of property subject to a document in progress.
